(19) United States
(12) Patent Application Publication
(10) Pub. No.: US 2022/0343883 A1
(43) Pub. Date: Oct. 27, 2022

(54) IMPROVEMENTS TO AUDIO PITCH PROCESSING

(71) Applicant: TECHNOLOGY CONNECTIONS INTERNATIONAL PTY LTD, North Ryde, New South Wales (AU)

(72) Inventor: Peter WALKER, North Ryde, New South Wales (AU)

(21) Appl. No.: 17/763,760

(22) PCT Filed: Sep. 25, 2019
(86) PCT No.: PCT/AU2019/051032

§ 371 Date: Mar. 25, 2022

(51) Int. Cl. G10H 1/12; G10L 21/013

(52) U.S. Cl. CPC G10H 1/125; G10L 21/013; G10H 2210/066; G10H 2210/325

(57) ABSTRACT

Disclosed are a method and device for processing an audio signal, in which a pitch processed signal 21 is mixed 33 with a high pass filtered 30 version of the input signal. This produces improvements in the latency and quality of the pitch processed signal, particularly for live performance.

### TECHNICAL FIELD

The present invention relates to electronic pitch processing, particularly in the context of the live performance of music.

### BACKGROUND OF THE INVENTION

Electronically manipulating the pitch of audio signals, specifically the human voice or instruments, is a common practice. It is used extensively in recording studios, film post-production and live performance. The intent varies, for example: to create a novel vocal effect by raising the pitch like Alvin and the Chipmunks (1958); or lowering the pitch to sound like an alien (in many horror films). In the modern era, pitch manipulation is often used to correct a poorly pitched vocal performance on musical records (e.g. using ‘Autotune®’, a dedicated pitch correction tool used in music recording studios).

Pitch manipulation is also used in live performance with instruments, particularly guitar. A whammy bar, which mechanically alters the tension of the guitar strings (and hence their pitch) is widely used to provide a pitch change or vibrato effect. Numerous guitar players are famous for whammy bar use (e.g. Hank Marvin, Jeff Beck, Eddie Van Halen, Steve Vai, Jimi Hendrix). Various mechanical whammy bar systems are in use.

The whammy bar effect is so popular that various electronic methods have been devised to create a facsimile without using a mechanical system. Modern electronic methods use computer processing to effect pitch change by sophisticated, high-speed algorithms (acting on the original audio signal) running in a dedicated digital signal processor, generically known as a pitch DSP. Pitch DSPs are also able to electronically emulate features such as a capo, which is a mechanical mechanism used to change the base tuning of the guitar.

Changing the pitch of a polyphonic audio signal computationally requires sophisticated mathematical analysis, data manipulation and signal reconstruction to produce a re-pitched audio output. That output (at a different pitch) should have a credible degree of resemblance to the input signal, but without altering the timing or length of the notes. It is considerably more complex than simply moving the fundamental pitch up or down to a desired frequency. The harmonics and transients also need to receive an appropriate shift, and maintain their phase and temporal relationships to the fundamental pitch.

There are numerous approaches employed in pitch processing algorithms. Improved algorithms and higher-speed processors have enabled useful products to be produced, but these are far from audibly ‘transparent’; the pitch-altered output is generally inferior to the original signal in various ways. These issues are particularly apparent in a performance situation, where near real-time outputs are required, as the altered pitch signal will often be accompanied by other instruments and voice which are performing live, and are not delayed by pitch processing.

One aspect of inferiority is the introduction of artefacts into the output: the pitch-shifted output signal has undesirable tonal characteristics (artefacts) as a result of a lack of precision in deconstructing the original signal and reconstructing it at a different pitch. These artefact problems (from framing errors, phase & transient smearing, spectral skewing etc.) are tackled with various algorithmic techniques, with varying degrees of success. As these artefacts do not exist in the original signal, they are often readily apparent to a listener.

Another aspect of inferiority is bandwidth: in order to minimise the complexity of analysis and lower the potential for harmonic artefacts, it is common to restrict the bandwidth of the signal being processed. For example, filtering out high frequencies of the input signal before processing relieves some of the burden on the processor/algorithm and reduces unwanted harmonic distortion and skewing, but at the expense of the fidelity of the output (especially when compared to the input signal). The frequencies that are filtered out before processing cannot be restored after the processing with ‘tone’ controls as they are no longer present in the input signal. Bandwidth filtering also decreases transient performance, compromising the initial transients (from striking the strings) - transient performance is a direct function of bandwidth.

A third aspect of inferiority is latency. All processing takes a finite time and hence introduces delay, or latency, into the output signal. Sufficiently short latency is not perceptible to the human ear, for example typically less than 15 to 20 ms. While latency may not be apparent to a casual listener, it is highly important to the performer. The performer is highly conscious of any delay in the presentation (i.e. arrival) of the sound they are creating. The delay may be perceived more as a feeling of being disconnected from the sound than an actual delay, which is very disconcerting. Of course, if the latency is too long, it will be apparent to the audience.

These three issues are be traded off by a developer of a pitch DSP to find an acceptable compromise among them all which is appropriate to the device/product being developed. For example, increasing bandwidth may lead to greater latency or more artefacts in the output signal.

It is an object of the present invention to provide a processing method and device, which achieves an improved balance between latency, artefacts and bandwidth.

### SUMMARY OF THE INVENTION

In a first broad form, the present invention provides a method of processing in which the input signal is duplicated in the analog domain. Then a first part is pitch processed with a DSP to produce a signal with a new fundamental pitch. A second part is at least high pass filtered in the analog domain. The first and second parts are then mixed in the analog domain, producing an output which has the re-pitched signal and an overlay of the original harmonics and transients. This improves the perceived bandwidth of the original signal.

According to one aspect, the present invention provides a method for processing an input audio signal, using a DSP device including at least the steps of: splitting the signal into first and second copies; inputting the first copy to the DSP device, to produce a pitch processed signal; in parallel, inputting the second copy to a high pass filter to produce a filtered output signal (i.e. the harmonics above the fundamental pitch); and mixing the pitch processed signal and the high pass filter signal to produce a composite output signal.

According to another aspect, the present invention provides a pitch processing device, including a DSP device, a splitter, a high pass filter and a mixer, wherein an input signal is split so as to be processed by the DSP device and the high pass filter in parallel, the DSP device producing a pitch shifted signal, the high pass filter producing a high pass filtered signal, the pitch shifted signal and the high pass filtered signal being mixed by the mixer, so as to produce an output signal.

In some implementations, the high pass filter and splitter may be implemented within the DSP device.

In suitable implementations, this process provides the DSP developer with a broader scope for the type and degree of compromises used for product-specific optimisation. In particular, application of the present invention can improve the perceived performance in bandwidth, with secondary improvement in perceived latency. If desired, these perceived improvements in bandwidth and latency can then be traded off (i.e. have less computation devoted to them) to allow more complex processing to reduce artefacts. Alternately, the composite pitch shifted sound output is perceived as of higher quality than the conventionally pitch shifted signal alone.

### BRIEF DESCRIPTION OF THE DRAWINGS

Implementations of the present invention will now be described with reference to the accompanying figures, in which:

FIG. 1 shows a block diagram of the signal processing according to an analog implementation of the present invention;

FIG. 2 illustrates Latency improvements in signals associated with the application of the present invention;

FIGS. 3, 4 and 5 are spectrum analyser graphs illustrating Bandwidth improvements in signals associated with the application of the present invention; and

FIG. 6 is a block diagram of a digital implementation of the present invention

### DETAILED DESCRIPTION OF THE INVENTION

The present invention will now be described with reference to specific examples and implementations. It will be understood that these are illustrative and not limitative of the scope of the present invention. In particular, the signal processing and mixing processes described could be performed in any suitable analog or digital system, or mix thereof. The specific arrangements described are only examples of many possible implementations, as will be apparent to those skilled in the art.

The present invention may be implemented in conjunction with any suitable pitch DSP, for example the DSP in a Whammy V by Digitech®), the PitchFork® by ElectroHarmonix or the Morpheus Dive Bomber®. The present invention does not require changes to the operation of the pitch change device itself, but rather adds additional components. Of course, the invention could be implemented in a device, or using yet to be developed alternative devices. It will be appreciated that in principle the pitch DSP may be only a component of a processor or system of processors.

Pitch is not an absolute entity derived from physical stimulus—it is a perceptual attribute (akin to ‘colour’), it is a psychoacoustic phenomenon. Human perception of pitch has been the subject of hypothesis and conjecture for centuries, with no completely definitive or fully agreed explanation of its many mechanisms.

Some aspects are now generally agreed. It is believed that the perception of any particular pitch in a complex signal is strongly influenced by the balance of the ‘partials’—the fundamental frequency versus the harmonics that are present. Even here, there is room for confusion (e.g. ‘the missing fundamental effect’, August Seeback circa 1840)—and the issue becomes even more complex when discussing stringed instruments. The vibration of a string is more correctly viewed as multiple individual vibrations, where the first harmonic above the fundamental is often not an exact multiple of the fundamental frequency (e.g. a string with a fundamental frequency of 200 Hz can have a 1st harmonic at 401 Hz).

The principle which underlies the present invention is that pitch of the upper harmonics of an audio signal (e.g. from a stringed instrument like a guitar) is poorly discerned—humans have no physiological or cognitive mechanism to discern pitch above certain frequencies. It is generally agreed that there is no mechanism for pitch discrimination above 5000 Hz, but this is the theoretical boundary. In practice, empirical testing by the inventor shows this boundary to be significantly lower, especially in live performance.

This may be due to numerous perceptual factors including: inattention (listening to music is usually a social function, not a technical one); volume (pitch interpretation is confused by volume—e.g. louder music is often interpreted to have higher pitch); and distraction/masking (the presence of multiple complex signals from numerous instruments greatly lowers the ability to interpret any single pitch accurately).

The present invention accordingly seeks to exploit the imprecision of human pitch determination at higher frequencies to improve the perceived performance of pitch DSPs.

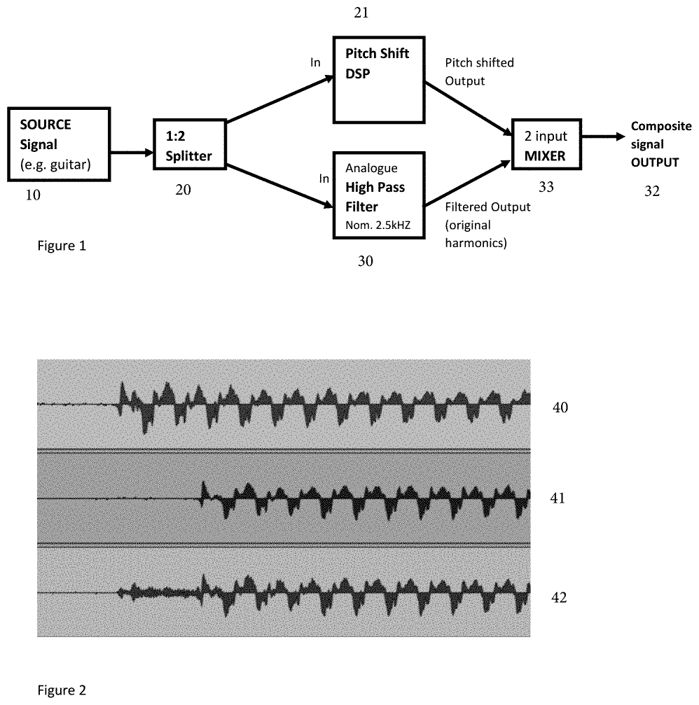

In overview, in one implementation the signal is processed as follows, and as illustrated schematically in FIG. 1:
1. The electronic source signal 10 (say, from an electric guitar) is fed to an analog splitter device 20 to provide two identical copies of the original signal (for example, a simple two-output analog buffer, as is well known to those in the art).
2. Copy ‘A’ is fed to a pitch shift DSP 21 (e.g. Whammy V by Digitech®).
3. Copy ‘B’ is fed to an analog audio high-pass-filter (HPF) 30 which filters out frequency components below a cut-off frequency from its output.
4. The output of DSP 21 is converted back to an analog audio signal (at a new pitch) and added using a simple analog mixer 33 to the HPF 30 output, producing a composite signal 32.

The HPF preferably has a moderately steep ‘slope’ (how quickly the frequencies are rolled off below the cut-off frequency, e.g. 24 dB per octave). It will be understood that the HPF output will be an analog signal composed only of harmonics above (say) 2.5 Khz, but at the original pitch of those harmonics present at the input.

The cut off frequency selected may vary depending upon the nature of the signal. For a guitar, a cut-off frequency of 2.5 kHz is more than twice the frequency of the fundamental of the highest possible note that can be played ('E′ at the 24th fret, the very top of the neck). In practice, most players will only play notes with a fundamental three times lower than a cut-off of 2.5 kHz ('A′ at the 17th fret).

FIG. 2 illustrates the audio signals temporally. The graphs depict amplitude against time, running from left to right. The top graph 40 is the original input signal. The middle graph 41 is the pitch shifted signal (the DSP output) with one semi-tone (or ‘half-step’) of pitch shift. It can be seen that it commences only after a delay, the period of latency, which will be discussed further below. The bottom graph 42 shows the composite of the high pass signal and the pitch shifted signal. The initial part of that graph shows only the high pass frequencies are present, as the pitch shifted signal has not yet emerged from the DSP processing.

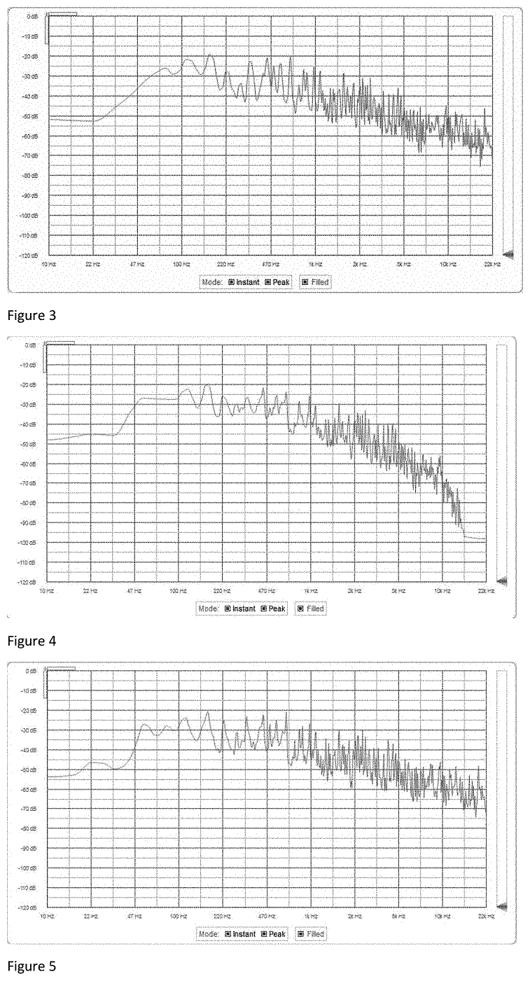

FIGS. 3, 4 and 5 are spectrum analyser images, illustrating the bandwidth improvement of an application of the present invention. FIG. 3 is the full-bandwidth output direct from an acoustic guitar. FIG. 4 is the band-limited output of a pitch DSP after pitch processing. FIG. 5 illustrates the application of an implementation of the present invention. It portrays the composite output signal when the original analog signal (after High Pass Filtering above 3.5 kHz in this example) is added to the pitch shifted signal (which was band-limited by the DSP pitch processing). The significant difference at higher frequencies between FIG. 4 and FIG. 5 is very apparent, leading to the user perception that the pitch DSP chain has full-bandwidth performance akin to FIG. 3.

It will be understood that the HPF signal is added to a pitch shifted signal with which it is not temporally aligned—the analog HPF output signal has transients and harmonics that are not delayed by analog processing, whereas the pitch shifted signal is delayed by DSP processing latency. In practice, it is not necessary for the harmonics and transients to be perfectly aligned to a precise relationship with the pitch shifted signal because human perception is tolerant of these discrepancies provided they are within reasonable bounds. Beneficially, the pitch shifted signal now only needs to encompass a more limited bandwidth, corresponding for example to the cut off frequency selected for the HPF. In practice, these two bandwidth roll-offs (DSP processor and HPF) need not be precisely aligned as, once again, perception does not require high levels of precision.

Perceptually, three beneficial effects are derived from suitable implementations of the present invention. First, the bandwidth of the resultant composite signal is perceptually a much better match to the input signal (the final output signal has the band-limited, pitch-shifted signal plus the non-pitch-shifted upper harmonics of the input signal). This is highly significant to players who want to maintain their original ‘tone’.

Second, the HPF signal component includes the initial transients (from striking the strings). This is beneficial, as a common problem which is encountered when pitch is shifted a significant amount by DSP processing is phase and transient smearing, leading to the processed signal sounding dull and blurred.

Third, because there is no latency in the HPF signal added to the composite output—as it is derived with analog circuitry, not computer processing—the players' perception of latency is greatly diminished. The analog circuits used in the implementation described are all common-place designs well known to those in the audio electronic arts and may be implemented with simple op-amp technology using standard I.Cs, for example the TL074, OPA2134.

In practice, several factors contribute to the overall effectiveness of any successful implemention of the present invention.

There is no perception of pitch discrepancy between the two component signals because human cognition and auditory pathways are unable to discriminate between them.

The perceived bandwidth of the composite output sounds entirely ‘natural’ because it is derived from the actual harmonics of the input signal—not a manufactured or ‘tweaked’ recreation. As a result, the fidelity of reproduction is perceived as a close match to the original signal.

Matching the HPF cut-off characteristics (slope & frequency) to complement the band-limiting characteristics (slope & frequency) in the DSP process ensures a seamless transition between the two components of the output signal. In practice, it may be preferred to have these roll-off characteristics overlapping or separated to better match the pitch transform required and/or the musical/tonal preference of the player.

The nominal latency period of contemporary pitch DSPs is, of commercial necessity, below acceptable limits (i.e. <20 mS). This does not imply it is not a deterrent to use—it is merely ‘good enough’ as a compromise. However, this latency period is short enough that the initial transient (supplied by the HPF filter) seamlessly blends with the (delayed) pitch-processed signal to form a perceptually contiguous signal. This is highly desirable in performance as it provides the illusion of near-zero latency to the player.

It will be appreciated that this implementation is a basic implementation, and that numerous alternatives and additions could be used to exploit the underlying inventive concept.

For example, selectable cut-off frequencies in the HPF could be provided to match the ‘tone’ profile required by the type or style of music, for example acoustic players will likely want the full extended bandwidth on offer while ‘heavy metal’ players may prefer a restricted band width (e.g. less extreme high frequencies) as they commonly employ high-gain amplifiers and fuzz boxes. These do not reproduce extreme high frequencies in a desirable way.

To this end, the HPF could be substituted by a band-pass filter (BPF), which limits the lower and upper frequency of the harmonics allowed to pass through. This allows additional control of the very high frequencies, discriminating against them. This can be desirable in certain music styles (e.g. ‘heavy metal’ as discussed above)

The ratio of mixing the original harmonics with the re-pitched signal can be dynamically varied with some advantage in operation. For example, a signal that is re-pitched significantly lower (e.g. one octave) may benefit from a higher level (e.g. 2:1) of original harmonics to account for the inescapable harmonic roll-off caused by the re-pitching algorithm and the normal phase/transient smearing the processing causes.

The cut-off frequency of the HPF or BPF, can be dynamically varied with some advantage in operation. For example, a signal that is re-pitched significantly lower (e.g. one octave) may benefit from a lower HPF cut-off frequency, to match with the lower pitched harmonic content produced by the re-pitching algorithm.

None of these alterations will affect the apparent latency improvement already described.

In an alternative implementation, the HPF process can be readily implemented in the digital domain. HPF code is readily implemented, as will be apparent to those skilled in the art. It can operate with very low latency (˜1-2 mS) in a simple and inexpensive processor. However, the digital HPF filtering is preferably in the pitch DSP itself. In this way, one A/D converter can feed both processes and the results of both processes can be proportionally mixed (in digital) within the DSP.

As a result, analog HPF components are eliminated, as is the need for a separate final analog mixing stage.

A digital implementation allows for discretionary time-alignment of the ‘non-pitched’ HPF signal versus the ‘re-pitched’ DSP signal by adding a defined delay to the HPF signal. Again, the delay code is simple to implement and can be done with a cheap CPU or preferably within the pitch DSP.

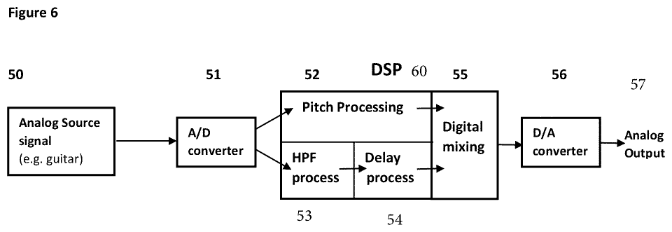

FIG. 6 is a schematic illustration of such a digital implementation. The analog source signal 50, for example from a guitar, is passed to analog to digital converter 51, which outputs two identical digital signals in parallel to the DSP 60.

A first signal is processed by the pitch processor 52 to produce the desired pitch shifted signal. A second signal is processed by the HPF process 53 in the DSP, and then processed though a delay process 54, Both signals are mixed digitally 55, to produce a digital output signal for digital to analog converter 56. The desired analog output 57 is then generated.

1.-11. (canceled)

12. A method for processing an input audio signal during live performance, using a DSP device comprising at least the steps of:
(a) splitting the input audio signal into first and second copies;
(b) inputting the first copy to the DSP device, to produce a pitch processed signal,
(c) in parallel, inputting the second copy to a high pass filter to produce a high pass filter signal;
(d) mixing the pitch processed signal and the high pass filter signal to produce an output signal.

13. A method according to claim 12, wherein the pitch processing signal and the high pass filter signal are not temporally aligned.

14. A method according to claim 13, wherein the latency of the pitch processed signal relative to the high pass filter signal is less than about 25 ms.

15. A method according to claim 12, wherein the high pass filter has a cut off frequency, and the bandwidth of the pitch processed signal has an upper bound of about the cut off frequency.

16. A method according to claim 12, wherein the two copies are produced as outputs from an analog to digital converter, and the high pass filter is implemented digitally.

17. A method according to claim 16, wherein the high pass filter is implemented within the DSP device.

18. A pitch processing device, comprising a DSP device, a splitter, a high pass filter and a mixer, the splitter being adapted to receive an input audio signal, and to operatively generate a first and a second split signal in parallel, the first split signal being connected to the DSP device and the second split signal being connected to the high pass filter, and the DSP device output and the high pass filter output being connected to the mixer, wherein operatively the DSP device output is a pitch processed signal, and the DSP device output and the high pass filtered signal are mixed by the mixer, so as to produce an output signal.

19. A device according to claim 18, wherein the wherein the pitch processed signal and the high pass filtered signal are not temporally aligned.

20. A device according to claim 19, wherein the high pass filter has a cut off frequency, and the bandwidth of the pitch processed signal has an upper bound of about the cut off frequency.

21. A device according to claim 18, wherein the high pass filter and mixer are digital, the output signal from the DSP is digital, and wherein device further comprises a digital to analog converter connected to the mixer so as to produce an analog output signal.

22. A device according to claim 21, wherein the high pass filter and mixing are performed with the DSP device.
